(19) United States
(12) Patent Application Publication
(10) Pub. No.: US 2014/0337149 A1
(43) Pub. Date: Nov. 13, 2014

(54) SYSTEMS, METHODS, AND DEVICES FOR A ROTATION-BASED ORDER MODULE

(71) Applicant: Taco Bell Corp., Irvine, CA (US)

(72) Inventors: Tony Ke Ke, New York, NY (US); Andrew Carlson, New York, NY (US); Reynald Benoit, Jersey City, NJ (US); Jessie Harte, New York, NY (US); Eissa Bonamo, Boston, MA (US)

(73) Assignee: Taco Bell Corp., Irvine, CA (US)

(21) Appl. No.: 14/201,631

(22) Filed: Mar. 7, 2014

Related U.S. Application Data
(60) Provisional application No. 61/778,186, filed on Mar. 12, 2013.

(51) Int. Cl. G06Q 30/06; G06F 3/0482; G06F 3/0484; G06Q 50/12; G06F 3/01

(52) U.S. Cl. CPC G06Q 30/0635; G06Q 50/12; G06F 3/017; G06F 3/04842; G06F 3/0482
USPC 705/15; 705/26.81; 345/156

(57) ABSTRACT

In an embodiment, the system can be configured to allow a user to quickly order a repeat item by simply rotating the mobile device or other computing system of the user to a horizontal orientation. By positioning the mobile device or other computing system in a horizontal orientation, the system can be configured to remove the existing contents on the display, display the necessary information for previously placed orders, and reorient the contents for correctly displaying the content in a horizontal orientation, thereby increasing the amount of display area for presenting data to a user, from the perspective of margin width.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

In particular, this application claims benefit of U.S. Provisional Patent Application Ser. No. 61/778,186 filed Mar. 12, 2013, which is hereby incorporated by reference in its entirety.

### BACKGROUND

1. Field of Disclosure

The disclosure relates generally to the field of mobile devices, and more particularly to systems for a rotation-based ordering mechanism.

2. Description of the Related Art

With the development of mobile devices and other computing systems, it is now possible to place an order for items and services direct from a mobile device or other computing system. For example, it is now possible to order food items at a restaurant using a mobile device. In general, mobile devices and other computing systems have made it easier to locate items for purchase, as well as to order the item of interest. No longer must a consumer flip through page after page of a physical catalog or a menu in order to identify the service or good of interest.

Software applications operating on a mobile device or other computing system have allowed consumers to search directly for the products and services consumers want. By making it easier to locate and purchase services and goods, companies can increase the number of sale transactions. Accordingly, it can be advantageous to provide a system to consumers that make the process of locating and/or purchasing goods and services more efficient and effective, because such improvements can increase the number of sale transactions that a company can realize.

### SUMMARY

Advancements in the technology for mobile devices and other computing systems make it possible to improve the efficiency and effectiveness of locating and/or purchasing goods and services from a company.

In an embodiment, a rotation-based purchasing device comprises a computer network communication controller configured to communicate with a main server system through a computer network. The device can comprise a memory configured to store previously stored order data. In an embodiment, the device can comprise an orientation detection module configured to detect a change in orientation of the device. The device can comprise an output module configured to present at least one previously placed order in response to determining that the device is in a horizontal orientation, wherein the horizontal orientation is determined based on accessing the orientation detection module, wherein the at least one previously placed order is based on the previously stored order data stored in the memory. The device can comprise an input control configured to receive a selection of at least one previously placed orders presented by the output module. In an embodiment, the device can comprise an order processing module configured to generate an order data packet based on the selection received by the input control, the order data packet comprising at least the selection, a user identification, and a store identification. The device can comprise a computer network communication controller further configured to transmit the order data packet to the main server system through the computer network. In an embodiment, the orientation detection module comprises at least one of: an accelerometer, a gyroscope.

In an embodiment, a downloadable application, configured to be run on a processor (for example, on a processor of a mobile device, such as a smart phone), is accessible by a computer network communication controller configured to communicate with a main server system through a computer network. The downloadable application is configured to be stored on a computer-readable memory, the computer-readable memory configured to store past order data. The downloadable application can receive at least one orientation change signal responsively generated by at least one orientation sensor detecting a change in orientation of a rotatable device. The downloadable application is configured to present at least one previously placed order in response to the orientation change signal determining that the rotatable device is in a horizontal orientation, wherein the at least one previously placed order is based on the past order data stored in the computer-readable memory. The downloadable application is configured to generate an order data packet based on a selection of the at least one previously placed order, the order data packet comprising at least the selection, a user identification, and a store identification. The computer network communication controller is further configured to transmit the order data packet to the main server system through the computer network. In an embodiment, the orientation sensor comprises at least one of: an accelerometer, a gyroscope.

In an embodiment, the previously placed order is a restaurant order, or a medication order, a consumer products order, or an office supply order, or a grocery order, or a monthly bill payment order. In an embodiment, the previously placed order data is obtained from the main server system through the computer network. The computer network communication controller can be further configured to receive an order confirmation data packet from the main server system, and wherein the output module and/or downloadable application is further configured to present an order confirmation message based on the order confirmation data packet.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects, and advantages of the embodiments of the invention are described in detail below with reference to the drawings of various embodiments, which are intended to illustrate and not to limit the embodiments of the invention. The drawings comprise the following figures in which:

FIG. 1 is an embodiment of a schematic diagram illustrating a computing device displaying an ordering system.

FIG. 2 is an embodiment of a schematic diagram illustrating a user placing an order by using the ordering system on a computing device.

FIG. 3 is a block diagram depicting a high-level overview of an embodiment of a rotation-based ordering system.

FIG. 4 is a flow chart depicting an embodiment of a process for a rotation-based ordering system.

FIG. 5 is a flow chart depicting an embodiment of a process for a rotation-based ordering system.

FIG. 6 is a flow chart depicting an embodiment of a process for a rotation-based ordering system.

FIG. 7 is a block diagram depicting an embodiment of a computer system configured to run software for implementing one or more embodiments of the rotation-based ordering systems described herein.

### DETAILED DESCRIPTION OF THE EMBODIMENT

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and no single feature is solely responsible for its desirable attributes or is essential to practicing the inventions herein described.

In many instances, a consumer often orders the same items when entering a particular store. For example, many people will order a taco and a soda when entering a restaurant. Furthermore, it is increasingly common to order goods and services through a mobile phone or other computing device. In placing an order using a mobile device or other computing system, a consumer that often orders the same items will generally have to select each item from the menu in order to place the order for items that the user often orders. The foregoing scenario not only plays itself out in the food industry, but also this scenario is fairly commonplace in the context of prescription drugs, office supplies, groceries, monthly bill payment, consumer products, and the like. Accordingly, there is a need for a system to simplify the reordering process.

The development of mobile devices, such as smartphones and tablet computers and laptops, have made it easier for the consuming public to locate and/or purchase goods and/or services from sellers. For example, a user can utilize a mobile device to access a menu of a restaurant. By utilizing the menu of the restaurant, the user can determine what food products to purchase and/or place an order for such food products. The challenge in utilizing mobile devices and other computing systems to place an order for goods and/or services is, generally these mobile devices and other computing systems do not allow for a user to place an order for items that are repeatedly ordered without having to type in all of the necessary information for completing the order.

Accordingly, in order to complete an order for repeatedly ordered items, a user must generally locate the repeatedly ordered item or service in a menu or a catalog, and then perhaps enter payment information and shipping information. Additionally, the laborious task of entering a repeat order can be a barrier for some consumers to place an order. Accordingly, it would be advantageous for increasing sales of repeat customers to utilize a system that employs a novel and easy mechanism for entering a repeat order.

It would be advantageous to configure a mobile device or other computing system to allow for ordering of repeat or previously placed orders that are commonly made by a consumer. However, the challenge in creating such a system is that generally, the display size of mobile devices and other computing systems have limited screen size for displaying data. Generally, the display of previously placed orders requires a display area sufficiently large to provide such information to a user. To solve this challenge, the systems and methods disclosed herein provide for a rotation-based ordering system.

In an embodiment, a purchase ordering system enables a user to rotate a mobile device from a vertical orientation to a horizontal orientation (or vice versa), whereby the mobile device is configured to display one or more previously ordered items or orders from which the user can select to reorder. For example, a user could use such a system in order to place an order for food at a restaurant by simply rotating the mobile device from a vertical orientation to a horizontal orientation which causes the mobile phone to display previously placed food orders.

In an embodiment, the system can be configured to allow a user to quickly order a repeat item by simply rotating the mobile device or other computing system of the user to a horizontal orientation. In an embodiment, the system can be configured to allow a consumer to rotate the mobile device of the user in order to re-order. By positioning the mobile device or other computing system in a horizontal orientation, the system can be configured to enter into an alternative display state. In the alternative display state, the system can change the display to show information for previously placed orders. In other words, by rotating the mobile device or other computing system to a horizontal orientation, the system can remove the existing contents on the display and display only previous orders in a horizontal direction. In an alternative embodiment, by positioning the mobile device or other computing system in a horizontal orientation, the system can be configured to reorient the contents for correctly displaying the content in a horizontal orientation, thereby increasing the amount of display area for presenting data to a user, from the perspective of margin width. In other words, by rotating the mobile device or other computing system to a horizontal orientation, the system can display additional data in a horizontal direction. In such an embodiment, the added display area in a horizontal direction can allow the system to show the necessary information for previously placed orders along with the content selected in the vertical orientation.

The rotation-based ordering systems disclosed herein can further be advantageous because they provide a simple and novel way for a user to place an order that has been previously placed in the past. Typically, a user would have to re-enter a previously placed order item manually in order to place the order. Then, a user would have to hit a “submit” or “place order” button.

By utilizing the systems disclosed herein, a user need not manually enter in a previously placed order. Rather, the user would only need to rotate the user's mobile device or other computer system into a horizontal orientation. By placing the mobile device or other computer system in a horizontal orientation, the system can be configured to display previously placed orders. Optionally, the system can be configured to display previously provided payment information, such that the user need not manually enter such information into the system again. Additionally, the system can be optionally configured to display previously selected store, restaurant or other fulfillment entity information, such that the user need not enter such information manually. The foregoing information can all be displayed on a user's mobile device or other computing system by simply rotating the user's mobile device or other computing system from a vertical position to a horizontal position or a substantially horizontal position.

In an embodiment, the terms “horizontal position,” “horizontal orientation,” “substantially horizontal position” as used herein are interchangeable terms and refer to when the mobile device or other computing system is positioned horizontally or is positioned at about 80°-100° from the vertical axis of the mobile device that is parallel to the direction of the force of gravity. The foregoing tolerance range for determining a substantially horizontal orientation can vary without deviating from the spirit of the embodiments disclosed herein, for example, the tolerance range can be 75°-105°, or 70°-110°, or the like. The rotation-based ordering systems disclosed herein can be utilized in a variety of software applications and purchasing contexts.

For example, the rotation-based ordering systems disclosed herein can be used in a mobile application context. In an embodiment, a user can download a mobile application onto the mobile device of the user. The mobile application can be configured to allow the user to order food items from a particular restaurant. The user can activate the mobile application by clicking the icon on the mobile device. When the mobile application has been launched, the user immediately sees a “home” screen for the mobile application.

In an embodiment, the “home” screen can display a traditional menu of available food products for purchase. Typically, the user will activate the mobile application while the phone is in a vertical position or portrait orientation. While in the portrait orientation, the user can scroll through the menu to peruse the various food items available for consumption. The mobile application can be configured with one or more of the rotation-based ordering systems disclosed herein. Accordingly, the rotation-based ordering system can be configured to detect when the user has rotated the user's mobile device from a vertical position or portrait orientation to a horizontal position or landscape orientation.

By positioning the mobile device in a horizontal position or landscape orientation, the rotation-based ordering system can be activated to display previously placed orders that the user has purchased in the past. In one embodiment, as described above, by positioning the device in the horizontal orientation or landscape orientation, the system can remove the existing contents on the display and display only previous orders in the horizontal direction. The content data displayed on the display screen of the mobile device are reoriented such that the content data is correctly displayed right-side-up in the landscape orientation. In an alternative embodiment, by positioning the device in the horizontal orientation or landscape orientation, the system can display both the existing contents on the display and previously placed orders. The content data displayed on the display screen of the mobile device are reoriented such that the content data is correctly displayed right-side-up in the landscape orientation. In such an embodiment, by reorienting the content data in the landscape orientation, the system can display the existing contents and additional content data in a horizontal direction, because there is additional screen real estate for which to present content data to the user. This additional real estate allows the system to better display previously placed orders.

In an embodiment, the mobile application can be configured to display one or more previously placed past orders on the display screen of the mobile device. The user can swipe through and peruse through the previously placed orders in order to make a selection. In an embodiment, the previously placed past orders that are displayed on the mobile device are specific to a particular restaurant, store, or fulfillment entity. Alternatively, the previously placed past order that are displaced on the mobile device are not specific to a particular restaurant, store, or fulfillment entity, but rather the listing of previously placed orders are from a plurality of restaurants, stores, or fulfillment entities.

Optionally, the system can be configured to display previously provided payment information that was utilized in past orders placed by the user. Further, the system can be optionally configured to display previously provided restaurant information from which the user previously placed an order for food. In the landscape orientation, the user can select an icon representing a previously placed order for food and then hit a “purchase” button. By selecting the previously placed order and the “purchase” button, the system can be configured to send an order to a main server system that can process the order. Alternatively, the system can be configured to allow the user to select and/or purchase a previously placed food order by speaking to the mobile device of the user. In an embodiment, the order can comprise the food items ordered and the quantity of each item desired for purchase.

In an embodiment, once in the rotated, horizontal, and/or alternative display state, the system can allow the user to purchase one or more displayed previously placed orders. In one embodiment, the user can purchase previously placed orders by rotating the mobile device or other computing system again, in either the same direction or a different direction than the original direction of rotation. In another embodiment, the user can purchase previously placed orders by shaking, rolling or providing some other physical gesture to the mobile device or other computing system. In another embodiment, the user can purchase previously placed orders by swiping across the screen of the mobile device or other computing system. In another embodiment, additionally or alternatively, the user can swipe back or rotate in the reverse direction (relative to the original rotation direction) to go back to the previous display state. In another embodiment, swiping back or rotating in the reverse direction (in other words, rotating the mobile device or other computing system to the original portrait orientation) can allow the system to go back to the previous display state only if no previously placed orders have been selected. Alternatively, when one or more previously placed orders have been selected, swiping back or rotating the mobile device or other computing system in the reverse direction back to the portrait orientation would allow the user to purchase the previously placed orders.

In an embodiment, in the rotated, horizontal, and/or alternative display state, the system can allow the user to combine menu items for purchase. In one embodiment, the user can select one or more previously placed orders to reorder (e.g., with a check box for each previously placed order) to allow the user to purchase more than one previously placed order. In one embodiment, the user can purchase menu items not previously purchased and/or purchase one or more displayed previously placed orders (e.g. one new menu item and two previously placed orders). In one embodiment, the user can select, combine and purchase menu items from one or more previously placed orders (e.g., by selecting specific menu items from previously placed orders) and/or menu items not previously purchased.

In an embodiment, the system can be configured to send the main server system an item number that corresponds to the food items selected. In an embodiment, the system can be optionally configured to send with the order a restaurant location selection or an identification number corresponding to the selected restaurant location.

In an embodiment, the system can be configured to send with the order payment information stored on the mobile device or a payment identification number corresponding to payment information stored in the main server system.

After the order information has been transmitted by the mobile device over a computer network connection to the main server system, the order is processed by the main server system. The main server system can be configured to store the order information in a user account associated with the user. By storing the order information in the user account, the main server system can be configured to utilize past order information for data mining purposes. For example, the main server system can be configured to mine past order data in order to determine marketing campaigns to be applied to a particular user or group of users. Additionally, the main server system can be configured to mine past order data to determine a particular up-sell product to present to the user.

In an embodiment, the main server system can be configured to analyze the current order being made by the user and compare it with past orders by the user and/or past orders by other similar users, in order to determine a product to up-sell to the user. The main server system can be configured to select an up-sell product to present to the user based on the present order, past order history of the user, and/or the past order history of one or more other users.

In an embodiment, the main server system can be configured to transmit the up-sell product information through a computer network connection to the user's mobile device. The user's mobile device can be configured to display the up-sell product information on the mobile display. The mobile device can be configured to present a purchase button on the mobile device for allowing the user to purchase the up-sell product. If the user selects the purchase for the up-sell product, the mobile device can be configured to transmit the order information to the main server through a computer network connection.

In an embodiment, the main server system can be configured to analyze the order information to determine a restaurant location for fulfilling the user's order. In an embodiment, the order can comprise a restaurant location selected by the user. In this case, the main server system can be configured to transmit the order information to the selected store location through a computer network connection. In situations where the store location information is not provided with the order, the main server system can be configured to determine the best location for sending the order for fulfillment.

For example, in an embodiment, the mobile device can be configured to provide or send the geographic location of the mobile device when the mobile device transmits the order to the main server system. Based on the geographic position of the mobile device, the main server system can determine the nearest restaurant for fulfilling the user's food order. After determining the nearest location for the fulfillment of the food order, the main server system can be configured to transmit the order to the restaurant's location.

In an embodiment, the main server can be configured to send a receipt or confirmation message or confirmation code to the user's mobile device through the computer network connection. The mobile device can be configured to store the receipt, confirmation message, or confirmation number in the mobile device such that the user may present such confirmation to the restaurant location upon picking up the food order.

Optionally, the main server system can be configured to analyze and process the payment information provided with the order. By processing the payment information at the main server system, the restaurant location need not process the payment information and need only process the food order for the user. It can be advantageous to process the payment information at the main server system because the main server system may be able to process the payment information on a more cost-effective basis. Alternatively, the payment information can be processed by the restaurant location.

When the order is received by the restaurant location, a fulfillment system at the restaurant location can be configured to display the order for an employee at the restaurant location to process and fulfill the order. The user of the mobile device can then pick up his food order at the restaurant location. Optionally, the user can display the receipt stored in the user's mobile device to a cashier or a barcode reader in order to obtain the user's food order.

In an embodiment, the mobile application can store all new food orders in the memory of the mobile device. In an embodiment, the system can be configured to automatically add all new food orders to the list of previously placed orders that displayed when the mobile device is rotated into a horizontal orientation. In an embodiment, newly placed and/or previously placed food orders can be saved with custom order names automatically generated and/or user-generated. In an embodiment, the user can rename placed orders. In an embodiment, the system can be configured to add all new food orders to the list of previously placed orders only after a certain criteria is satisfied. For example, the criteria can comprise an order frequency threshold level and/or a period of time. For example, a new food order/item must be ordered at least three times within a one month period before the new food order/item is added to the list of previously placed orders. Another possible criterion can comprise a order/item price threshold level. For example, a new food order/item must be less than $50 in order for the new food order to be added to the list of previously placed orders. Other criteria are possible.

One of ordinary skill in the art will appreciate that the foregoing example can be applied to other circumstances and situations outside of the restaurant or food industries. For example, the foregoing system and any other of the rotation-based ordering systems disclosed herein, can be utilized in any industry where there are customers placing repeat orders for products and/or services. For example, the rotation-based ordering systems disclosed herein can be applied to medication orders, consumer product orders, office supply orders, grocery orders, monthly utility bill orders, and the like.

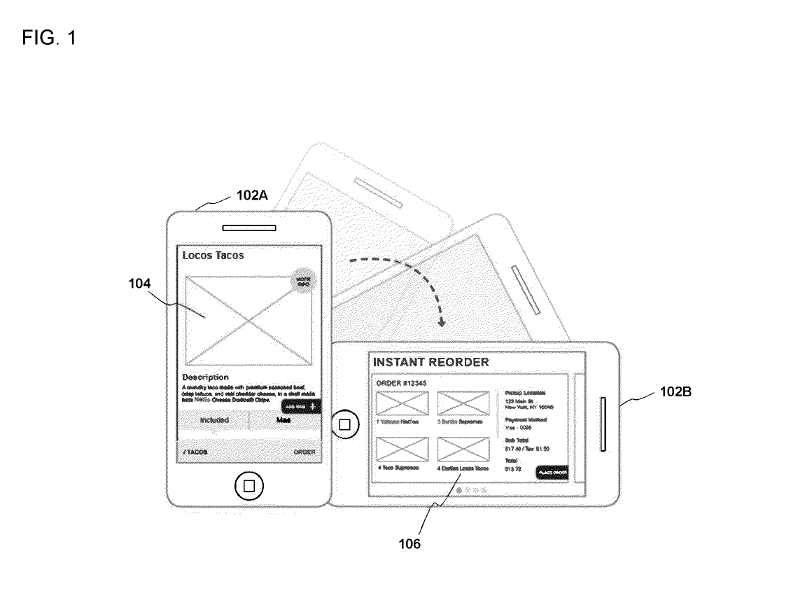

FIG. 1 is an embodiment of a schematic diagram illustrating a mobile device or other computing system 102. In an embodiment, the mobile device or other computing system 102 can be configured to operate a mobile application 104. The mobile application 104 can be a rotation-based ordering system that allows a user to place an order on the mobile device for fulfillment at a store location.

As illustrated in FIG. 1, the mobile device or other computing system 102 can be placed in a vertical position or portrait orientation 102a. The system can be configured to display a “home” page or other menu page when the mobile device or other computing system 102 is placed in a vertical position or portrait orientation 102a. The system can be configured to display on the mobile device or other computing system 102 an instant “order” page or a “previously placed order” menu page 106 when the mobile device or other computing system 102 is positioned in a horizontal position or landscape orientation 102b. By positioning the mobile device or other computing system in a horizontal position or landscape orientation 102b, the system can be configured to present to the user previously placed orders. The previously placed orders can include those that were purchased using a mobile device or other computing system and can include previously placed orders that were purchased using the rotation-based ordering system.

In an embodiment, the system can determine the orientation of the mobile device or other computing system 102 by interfacing with the hardware and software of the device. For example, many mobile devices comprise an operating system that allows application programs to call the operating system in order to determine the orientation of the mobile device. In many mobile phones, the operating system can be configured to interface with a gyroscope and/or accelerometer that are built into the mobile device. Based on detecting data from the accelerometer and/or the gyroscope in the mobile device, the operating system of the mobile device can determine the orientation of the mobile device. The orientation data determined by the operating system can be transmitted or passed to the software application for further processing by the software application.

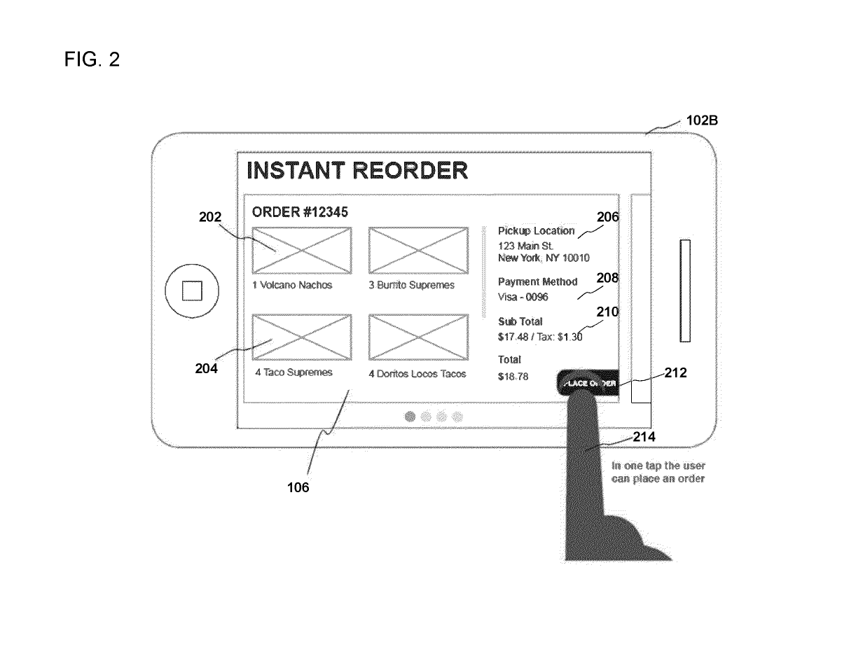

FIG. 2 is an embodiment of a schematic diagram illustrating a mobile device or other computing system 102 in a horizontal position or landscape orientation 102b. In the horizontal position or landscape orientation 102b, the system can be configured to display to the user prior-placed orders 202 using the rotation-based ordering system. In an embodiment, the system can be configured to additionally display prior-placed orders 204 using other systems other than the rotation-based system.

In an embodiment, the system can be configured to optionally display a store or fulfillment entity location 206. The store or fulfillment entity location 206 can be a previously provided store or fulfillment entity location selected by the user in a prior order. In an embodiment, the store or fulfillment entity location can be dynamically generated by the system based on the geographic position, as determined by the mobile device of the user. For example, the system can utilize the GPS location system of the mobile device to determine the geographic location of the user. The system, based on the geographic location, can determine the nearest store or fulfillment entity location for fulfilling the order.

In an embodiment, the system can be configured to display payment information 208. The payment information 208 can be payment information that the user previously provided or used in paying for prior-placed orders. In an embodiment, the system can be configured to interface with an electronic wallet stored on the mobile device in order to dynamically obtain payment information for placing an order. In an embodiment, the system can be configured to display a purchase order total 210. The purchase order total 210 can be dynamically generated based on the selected prior-placed order. In an embodiment, the system can be configured to display an order button 212 which the user's finger 214 can select for placing an order.

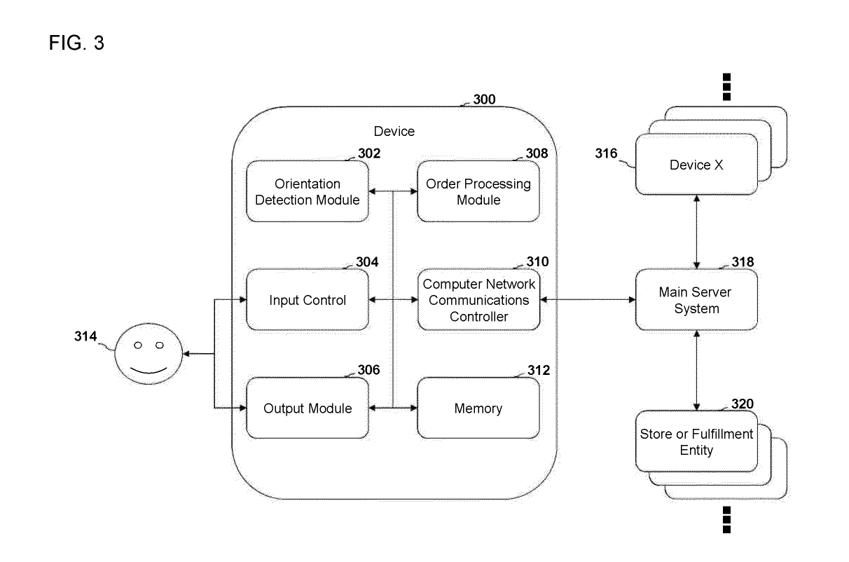

FIG. 3 is a block diagram depicting a high-level overview of an embodiment of a rotation-based ordering system. In an embodiment, the rotation-based ordering system comprises a device 300, which can include, without limitation, a mobile device, tablet computer, laptop computer, smartphone, or other computing device.

In an embodiment, the device 300 can comprise an orientation detection module 302 for detecting the orientation of the device 300. In an embodiment, the device 300 can comprise an order processing module 308 configured to process orders placed by a user 314 of the device 300. In an embodiment, the device 300 can comprise a memory 312 for storing data, such as order processing data, receipt data, store data, and the like.

In an embodiment, the device 300 can comprise an input control 304 and an output module 306 for interfacing with the user 314. The input control 304 can be configured to receive input from the user 314. The output module 306 can be configured to display or present data or content to the user 314. In an embodiment, the device 300 can be configured to comprise a computer network communications controller 310 for interfacing with a main server system 318 over a computer network connection. The computer network connection can include, without limitation, wireless connections, cellular connections, wired connections, or a combination of the foregoing.

In an embodiment, the device 300 can communicate with the main server system 318 over text messaging protocol, HTTP protocol, or any other similar messaging protocol. In an embodiment, the main server system 318 can be configured to communicate with a plurality of other devices 316. The main server system 318 can communicate with device 300 and the plurality of other devices 316 in order to receive order information from various users 314. The main server system 318 can process such orders and send such order information to a store or fulfillment entity 310. In an embodiment, the main server system 318 can communicate with a plurality of stores or fulfillment entities 310. Stores or fulfillment entities 320 can be configured to receive order information from a main server system in order to fulfill the order placed by users 314.

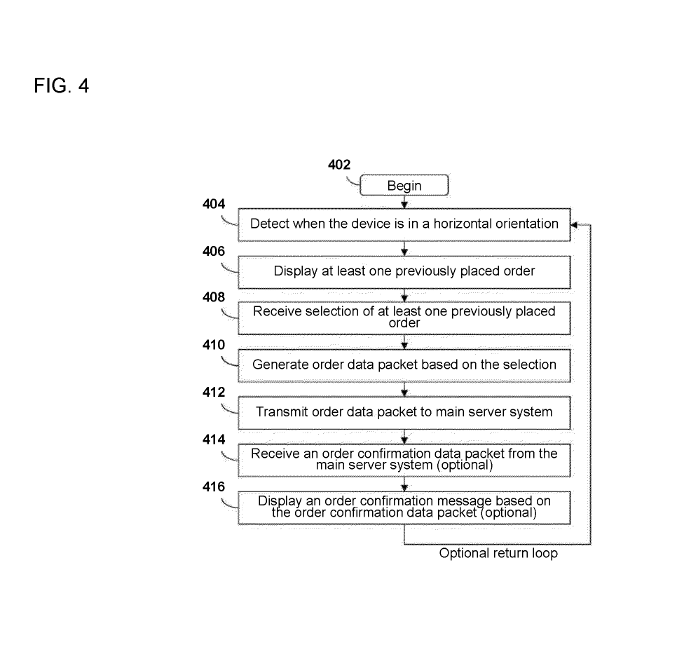

FIG. 4 is a flow chart depicting an embodiment of a process for a rotation-based ordering system. In an embodiment, the process can begin at block 402 and proceed to block 404 to detect when the device is in a horizontal orientation. At block 406, the system can be configured to display at least one previously placed order. At block 408, the system can be configured to receive selection information or data of at least one previously placed order from the user. At block 410, the system can be configured to generate an order data packet based on the selection placed by the user. At block 412, the system can be configured to transmit the order data packet to a main server system through a computer network connection.

At block 414, the system can be configured to optionally receive an order confirmation data packet from the main server system through a computer network connection. At block 416, the system can be configured to optionally display an order confirmation message based on the order confirmation data packet that was received from the main server system. In an embodiment, the system can be configured to optionally return to block 404 to detect the next time period when the device is positioned in a horizontal orientation.

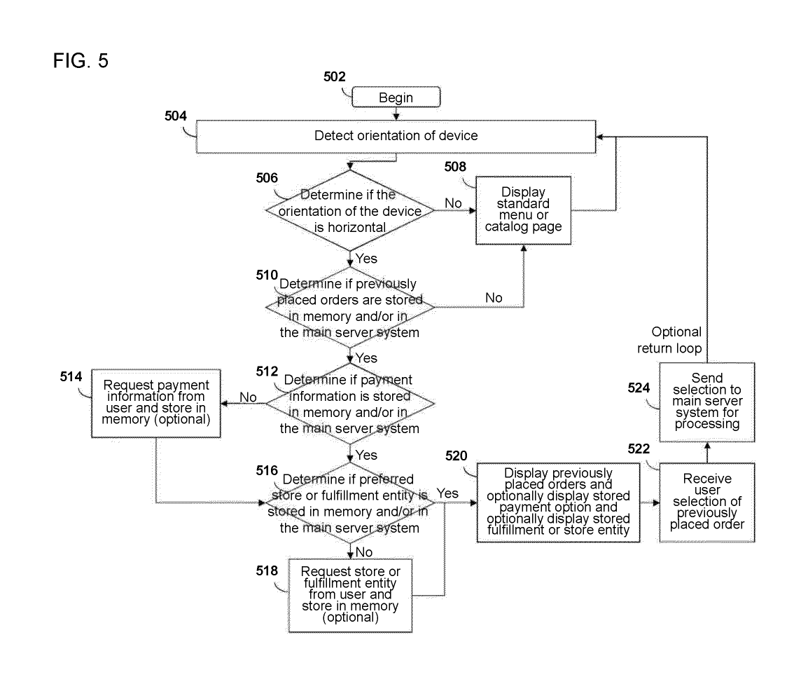

FIG. 5 is a flow chart depicting an embodiment of a process for a rotation-based ordering system. The process can begin at block 502 and proceed to block 504 to detect the orientation of the device. At decision block 506, the system can be configured to determine if the orientation of the device is in a horizontal orientation. If the system determines that the mobile device is not in a horizontal position, then the system, at block 508, can be configured to display the standard menu or catalog page. The system can then be configured to return back to block 504 to determine the next orientation of the device.

Returning to decision block 506, if the system detects that the orientation of the device is horizontal, then the system, at decision block 510, can be configured to determine if previously placed orders are stored in memory of the device and/or are stored in the main server system. If no previously placed orders are stored in the memory of the device and/or are stored in the main server system, the system can be configured to display standard menu or catalog page information at block 508 and return back to block 504.

If the system, at decision block 510, determines that there is stored previously placed order data, then the system, at decision block 512, can be configured to determine if payment information is stored in the memory of the device and/or in the main server system. If the system determines that there is no payment information stored, then the system, at block 514, the system can be configured to optionally request payment information from the user and store it in the memory of the device. The request for payment information can be made directly to the user through the mobile device or, alternatively, the request for payment information can be made by the mobile device to an electronic wallet stored in the mobile device.

If the system determines, at block 512, that payment information is stored in memory or that the system has received payment information, then the system, at decision block 516, can be configured to determine if a preferred store or fulfillment entity location is stored in memory and/or is stored in the main server system. If there is no known store or fulfillment entity location information, then at block 518, the system can be configured to optionally request store or fulfillment entity information from the user and store it in memory.

At block 520, the system can be configured to display previously placed orders and optionally display stored payment information and optionally stored fulfillment or store entity information. At block 522, the system can be configured to receive a user's selection of a previously placed order. At block 524, the system can be configured to send the selection to the main server system for processing. The system can be configured to optionally return to block 504 to detect the orientation of the device.

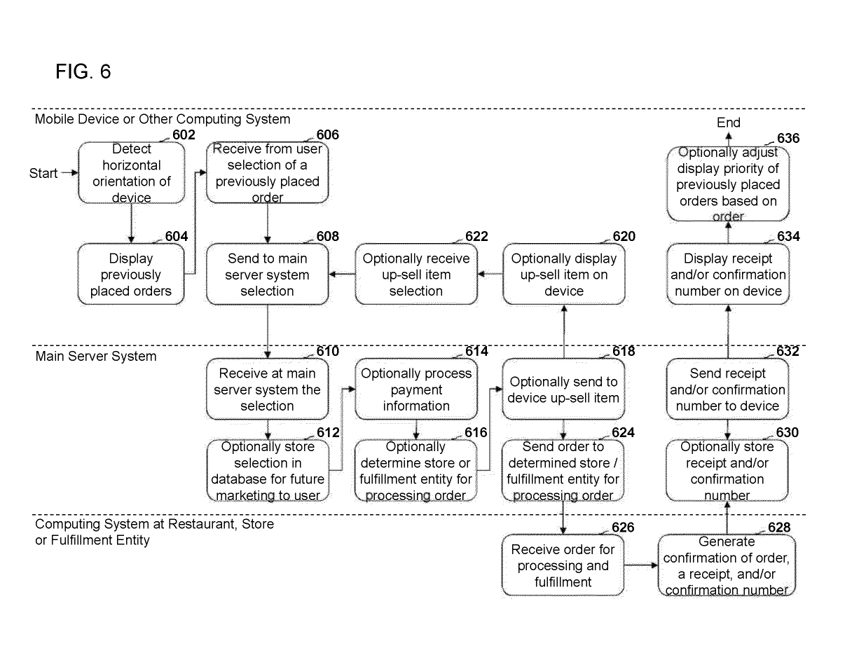

FIG. 6 is a flow chart depicting an embodiment of a process for a rotation-based ordering system. The process can start at block 602 by detecting the horizontal orientation of the device. At block 604, the system can be configured to display previously placed order on the device. At block 606, the system can be configured to receive from the user of the device a selection of a previously placed order. At block 608, the system can be configured to send from the device to the main server system, the selection received by the user. At block 610, the main server system can be configured to receive from the device for selection from the user.

At block 612, the system can optionally store the selection that was submitted by the user in a database for future marking to the user. At block 614, the system can optionally process the payment information received from the device with the order. At block 616, the system can be configured to optionally determine a store or fulfillment entity for processing the order. At block 618, the system can be configured to optionally send an up-sell item to the device for presentation to the user. At block 620, the device can be configured to optionally display the up-sell item on the device for the user to review.

At block 622, the system can be configured to optionally receive and up-sell a selection from the user. At block 608, the system can be configured to send to the main server system the selection of the up-sell item. At block 624, the system can be configured to send the order to the determined store or fulfillment entity for processing of the order. At block 626, the order is received by the store or fulfillment entity for processing and fulfillment. At block 628, the system can be configured to generate a confirmation of the order, a receipt, and/or a confirmation number for transmitting to the main server system and/or the mobile device.

At block 630, the system can be configured to optionally at least store the receipt and/or the confirmation number at the main server system. At block 632, the system can be configured to send the receipt and/or the confirmation number to the device. At block 634, the system can be configured to display and/or store receipt and or confirmation number on the device, for the user's review.

At block 636, the system can be configured to optionally adjust the display priority of previously placed orders based on the current order. For example, the system can be configured to display previously placed orders on a priority-ranking basis. In an embodiment, the priority-ranking basis can be based on the number of times a user has previously placed the same prior-placed order. For example, prior-placed orders with the highest number of orders appear at the top of the priority list.

In an embodiment, the system can be configured to dynamically adjust the prioritization of the prior-placed orders, based on the current order. Specifically, the system can be configured to add another order to the prior-placed order and to determine whether the additional order to the prior-placed order is sufficient to readjust the prioritization of the listing of prior-placed orders. In an embodiment, the system can end the process at block 636.

Computing System

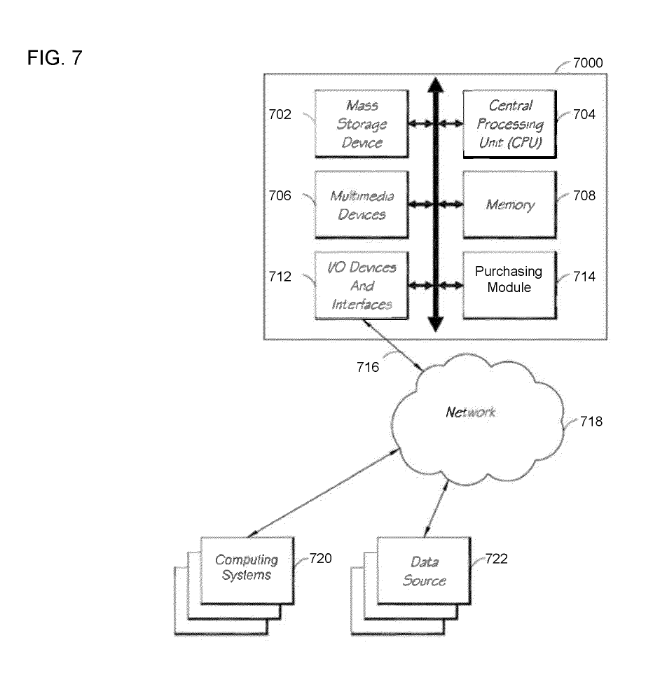

In some embodiments, the computer clients and/or servers described above take the form of a computing system 700 illustrated in FIG. 7, which is a block diagram of one embodiment of a computing system that is in communication with one or more computing systems 720 and/or one or more data sources 722 via one or more networks 718. The computing system 700 may be used to implement one or more of the systems and methods described herein. In addition, in one embodiment, the computing system 700 may be configured to apply one or more of the rotation-based ordering methods and systems described herein. While FIG. 7 illustrates an embodiment of a computing system 700, it is recognized that the functionality provided for in the components and modules of computing system 700 may be combined into fewer components and modules or further separated into additional components and modules.

Rotation-Based Ordering Control System

In an embodiment, the system 700 comprises a rotation-based ordering system module 714 that carries out the functions described herein with reference to rotation-based ordering mechanisms, including any one of the rotation-based ordering methods described above. The rotation-based ordering system module 714 may be executed on the computing system 700 by a central processing unit 704 discussed further below.

In general, the word “module,” as used herein, refers to logic embodied in hardware or firmware, or to a collection of software instructions, possibly having entry and exit points, written in a programming language, such as, for example, COBOL, CICS, Java, Lua, C or C++ or Objective C. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Computing System Components

In an embodiment, the computing system 700 also comprises an iPhone®, iPad®, or other computing devices suitable for controlling and/or communicating with large databases, performing transaction processing, and generating reports from large databases. The computing system 700 also comprises a central processing unit (“CPU”) 704, which may comprise a conventional microprocessor. The computing system 700 further comprises a memory 708, such as random access memory (“RAM”) for temporary storage of information and/or a read only memory (“ROM”) for permanent storage of information, and a mass storage device 702, such as a hard drive, diskette, or optical media storage device. Typically, the modules of the computing system 700 are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The computing system 700 comprises one or more commonly available input/output (I/O) devices and interfaces 712, such as a keyboard, mouse, touchpad, and printer. In one embodiment, the I/O devices and interfaces 712 comprise one or more display devices, such as a monitor, that allows the visual presentation of data to a user. More particularly, a display device provides for the presentation of GUIs, application software data, and multimedia presentations, for example. In the embodiment of FIG. 7, the I/O devices and interfaces 712 also provide a communications interface to various external devices. The computing system 700 may also comprise one or more multimedia devices 706, such as speakers, video cards, graphics accelerators, and microphones, for example.

Computing System Device/Operating System

The computing system 700 may run on a variety of computing devices, such as, for example, a mobile device or a server, a Windows server, an Structure Query Language server, a Unix server, a personal computer, a mainframe computer, a laptop computer, a cell phone, a personal digital assistant, a kiosk, an audio player, a smartphone, a tablet computing device, and so forth. The computing system 700 is generally controlled and coordinated by operating system software, such as iOS, z/OS, Windows 95, Windows 98, Windows NT, Windows 2000, Windows XP, Windows Vista, Windows 7, Linux, BSD, SunOS, Solaris, or other compatible operating systems. In Macintosh systems, the operating system may be any available operating system, such as MAC OS X. In other embodiments, the computing system 700 may be controlled by a proprietary operating system. Conventional operating systems control and schedule computer processes for execution, perform memory management, provide file system, networking, and I/O services, and provide a user interface, such as a graphical user interface (“GUI”), among other things.

Network

In the embodiment of FIG. 7, the computing system 700 is coupled to a network 718, such as a LAN, WAN, or the Internet, for example, via a wired, wireless, or combination of wired and wireless, communication link 716. The network 718 communicates with various computing devices and/or other electronic devices via wired or wireless communication links. In the embodiment of FIG. 7, the network 718 is communicating with one or more computing systems 720 and/or one or more data sources 722.

Access to the rotation-based ordering system module 714 of the computer system 700 by computing systems 720 and/or by data sources 722 may be through a web-enabled user access point such as the computing systems' 720 or data source's 722 personal computer, cellular phone, laptop, or other device capable of connecting to the network 718. Such a device may have a browser module is implemented as a module that uses text, graphics, audio, video, and other media to present data and to allow interaction with data via the network 718.

The browser module may be implemented as a combination of an all points addressable display such as a cathode-ray tube (CRT), a liquid crystal display (LCD), a plasma display, touch screen display or other types and/or combinations of displays. In addition, the browser module may be implemented to communicate with input devices 712 and may also comprise software with the appropriate interfaces which allow a user to access data through the use of stylized screen elements such as, for example, menus, windows, dialog boxes, toolbars, and controls (for example, radio buttons, check boxes, sliding scales, and so forth). Furthermore, the browser module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition a touch screen may act as a hybrid input/output device. In another embodiment, a user may interact with the system more directly such as through a system terminal connected to the score generator without communications over the Internet, a WAN, or LAN, or similar network.

In some embodiments, the system 700 may comprise a physical or logical connection established between a remote microprocessor and a mainframe host computer for the express purpose of uploading, downloading, or viewing interactive data and databases on-line in real time. The remote microprocessor may be operated by an entity operating the computer system 700, including the client server systems or the main server system, an/or may be operated by one or more of the data sources 722 and/or one or more of the computing systems. In some embodiments, terminal emulation software may be used on the microprocessor for participating in the micro-mainframe link.

In some embodiments, computing systems 720 that are internal to an entity operating the computer system 700 may access the rotation-based ordering system module 714 internally as an application or process run by the CPU 704.

User Access Point

In an embodiment, the computing system 700 comprises an iPhone®, an iPad®, Android computing system, a smartphone, a tablet computing device, a mobile device, a personal computer, a laptop computer, a cellular phone, a GPS system, a Blackberry® device, a portable computing device, a server, a computer workstation, a local area network of individual computers, an interactive kiosk, a personal digital assistant, an interactive wireless communications device, a handheld computer, an embedded computing device, or the like.

Other Systems

In addition to the systems that are illustrated in FIG. 7, the network 718 may communicate with other data sources or other computing devices. The computing system 700 may also comprise one or more internal and/or external data sources. In some embodiments, one or more of the data repositories and the data sources may be implemented using a relational database, such as DB2, Sybase, Oracle, CodeBase and Microsoft® SQL Server as well as other types of databases such as, for example, a signal database, object-oriented database, and/or a record-based database.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present invention herein disclosed should not be limited by the particular disclosed embodiments described above.

What is claimed is:

1. A portable computing device, comprising:
a display;
an orientation sensor detecting a change in orientation of the portable computing device and responsively generating an orientation change signal;
a computer-readable memory storing an application program; and
a processor executing the application program, the application program generating on the display a first set of visual representations corresponding to a first set of user interface options, the application program responsive to a first user interaction with the portable device to receive and process a first user input corresponding to a selected one of the first set of user interface options, the application program entering an alternative display state in response to the orientation change signal and changing the display to generate on the display a second set of visual representations corresponding to a second set of user interface options differing from the first set of user interface options, the application program in the alternative display state responsive to a second user interaction with the portable device to receive and process a second user input corresponding to a selected one of the second set of user interface options.

2. The portable computing device of claim 1, wherein the first and second user interactions are the same.

3. The portable computing device of claim 1, wherein the computer-readable memory stores at least one sequence of user inputs provided by a user, and wherein one of the options in the second set of user interface options is to provide the at least one sequence of user inputs to the application program.

4. The portable computing device of claim 1, wherein the orientation sensor comprises at least one of: an accelerometer, a gyroscope.

5. A portable computing device, comprising:
a display;
an orientation sensor detecting a change in orientation of the portable computing device and responsively generating an orientation change signal;
a computer-readable memory storing a restaurant ordering application program and storing data representing first and second sets of restaurant menu items;
a data transmitter; and
a processor executing the restaurant ordering application program, the application program generating on the display a first set of visual representations corresponding to the first set of restaurant menu items, the application program responsive to a first user interaction with the portable device to receive and process a first user input corresponding to a selected one of the first set of restaurant menu items and to cause the data transmitter to transmit first order data representing a request to order from a restaurant the selected one of the first restaurant menu items, the application program entering an alternative display state in response to the orientation change signal and changing the display to generate on the display a second set of visual representations corresponding to the second set of restaurant menu items, the application program responsive to a second user interaction with the portable device to receive and process a second user input corresponding to a selected one of the second set of restaurant menu items and to cause the data transmitter to transmit second order data representing a request to order from the restaurant the selected one of the second restaurant menu items.

6. The portable computing device of claim 5, wherein the computer-readable memory stores at least one sequence of user inputs representing selection of one or more preferred restaurant menu items, wherein one of the restaurant menu items in the second set of restaurant menu items corresponds to the preferred restaurant menu items, and wherein the application program in the alternative display state is responsive to a user interaction with the portable device to receive and process a user input corresponding to a selection of the one or more preferred restaurant menu items and to cause the data transmitter to transmit third order data representing a request to order from the restaurant the preferred restaurant menu items.

7. A portable computing device, comprising:
a display;
an orientation sensor detecting a change in orientation of the portable computing device and responsively generating an orientation change signal;
a computer-readable memory storing a restaurant ordering application program, storing menu item data representing a set of restaurant menu items, and storing past order data representing a set of requests to order restaurant menu items from a restaurant;
a data transmitter; and
a processor executing the restaurant ordering application program, the application program generating on the display a first set of visual representations corresponding to one or more of the restaurant menu items, the application program responsive to a first user interaction with the portable device to receive and process a first user input corresponding to a selected one of the first set of restaurant menu items and to cause the data transmitter to transmit first order data representing a request to order from the restaurant the selected one of the first restaurant menu items, the application program entering an alternative display state in response to the orientation change signal and changing the display to generate on the display a second set of visual representations corresponding to one or more of the set of requests to order restaurant menu items from the restaurant, the application program responsive to a second user interaction with the portable device to receive and process a second user input corresponding to a selected one of the requests to order restaurant menu items and to cause the data transmitter to transmit second order data representing a request to order from the restaurant the restaurant menu items represented in the selected one of the requests to order restaurant menu items.

8. A module configured to be run on a processor and stored on a computer-readable memory, the module comprising:
the module receiving at least one orientation change signal responsively generated by at least one orientation sensor detecting a change in orientation of a rotatable device;
the module generating on a display a first set of visual representations corresponding to a first set of user interface options, the module responsive to a first user interaction with the rotatable device to receive and process a first user input corresponding to a selected one of the first set of user interface options, the module entering an alternative display state in response to the at least one orientation change signal and changing the display to generate on the display a second set of visual representations corresponding to a second set of user interface options differing from the first set of user interface options, the module in the alternative display state responsive to a second user interaction with the rotatable device to receive and process a second user input corresponding to a selected one of the second set of user interface options.

9. The module of claim 8, wherein the first and second user interactions are the same.

10. The module of claim 8, wherein the computer-readable memory stores at least one sequence of user inputs provided by a user, and wherein one of the options in the second set of user interface options is to provide the at least one sequence of user inputs to the application program.

11. A restaurant ordering module configured to be run on a processor, the restaurant ordering module comprising:
the restaurant ordering module receiving at least one orientation change signal responsively generated by at least one orientation sensor detecting a change in orientation of a rotatable device;
the restaurant ordering module configured to be stored on a computer-readable memory wherein the computer-readable memory stores data representing at least a first set and a second set of restaurant menu items;
the restaurant ordering module generating on a display a first set of visual representations corresponding to the first set of restaurant menu items, the restaurant ordering module responsive to a first user interaction with the rotatable device to receive and process a first user input corresponding to a selected one of the first set of restaurant menu items and to cause a data transmitter to transmit first order data representing a request to order from a restaurant the selected one of the first restaurant menu items, the application program entering an alternative display state in response to the orientation change signal and changing the display to generate on the display a second set of visual representations corresponding to the second set of restaurant menu items, the restaurant ordering module responsive to a second user interaction with the rotatable device to receive and process a second user input corresponding to a selected one of the second set of restaurant menu items and to cause the data transmitter to transmit second order data representing a request to order from the restaurant the selected one of the second restaurant menu items.

12. The restaurant ordering module of claim 11, wherein the computer-readable memory stores at least one sequence of user inputs representing selection of one or more preferred restaurant menu items, wherein one of the restaurant menu items in the second set of restaurant menu items corresponds to the preferred restaurant menu items, and wherein the restaurant ordering module in the alternative display state is responsive to a user interaction with the rotatable device to receive and process a user input corresponding to a selection of the one or more preferred restaurant menu items and to cause the data transmitter to transmit third order data representing a request to order from the restaurant the preferred restaurant menu items.

13. A restaurant ordering module configured to be run on a processor, the restaurant ordering module comprising:
the restaurant ordering module receiving at least one orientation change signal responsively generated by at least one orientation sensor detecting a change in orientation of a rotatable device;
the restaurant ordering module configured to be stored on a computer-readable memory, wherein the computer-readable memory stores menu item data representing a set of restaurant menu items, and stores past order data representing a set of requests to order restaurant menu items from a restaurant;
the restaurant ordering module generating on a display a first set of visual representations corresponding to one or more of the restaurant menu items, the restaurant ordering module responsive to a first user interaction with the rotatable device to receive and process a first user input corresponding to a selected one of the first set of restaurant menu items and to cause a data transmitter to transmit first order data representing a request to order from the restaurant the selected one of the first restaurant menu items, the restaurant ordering module entering an alternative display state in response to the orientation change signal and changing the display to generate on the display a second set of visual representations corresponding to one or more of the set of requests to order restaurant menu items from the restaurant, the restaurant ordering module responsive to a second user interaction with the rotatable device to receive and process a second user input corresponding to a selected one of the requests to order restaurant menu items and to cause the data transmitter to transmit second order data representing a request to order from the restaurant the restaurant menu items represented in the selected one of the requests to order restaurant menu items.

14. A downloadable application configured to be run on a processor, the downloadable application comprising:
the downloadable application configured to be accessible by a computer network communication controller, the computer network communication controller configured to communicate with a main server system through a computer network;
the downloadable application configured to be stored on a computer-readable memory, the computer-readable memory configured to store past order data;
the downloadable application receiving at least one orientation change signal responsively generated by at least one orientation sensor detecting a change in orientation of a rotatable device;
the downloadable application configured to present at least one previously placed order in response to the orientation change signal determining that the rotatable device is in a horizontal orientation, wherein the at least one previously placed order is based on the past order data stored in the computer-readable memory;
the downloadable application configured to generate an order data packet based on a selection of the at least one previously placed order, the order data packet comprising at least the selection, a user identification, and a store identification; and
the computer network communication controller further configured to transmit the order data packet to the main server system through the computer network.

15. The downloadable application of claim 14, wherein the orientation sensor comprises at least one of: an accelerometer, a gyroscope.

16. The downloadable application of claim 14, wherein the previously placed order is a restaurant order.

17. The downloadable application of claim 14, wherein the previously placed order is a medication order.

18. The downloadable application of claim 14, wherein the previously placed order is a consumer products order.

19. The downloadable application of claim 14, wherein the previously placed order is an office supply order.

20. The downloadable application of claim 14, wherein the previously placed order is a grocery order.

21. The downloadable application of claim 14, wherein the previously placed order is a monthly bill payment order.

22. The downloadable application of claim 14, wherein the past order data is obtained from the main server system through the computer network.

23. The downloadable application of claim 14, wherein the computer network communication controller is further configured to receive an order confirmation data packet from the main server system, and wherein the downloadable application is further configured to present the an order confirmation message based on the order confirmation data packet.
